(19) United States
(12) Patent Application Publication
(10) Pub. No.: US 2017/0210238 A1
(43) Pub. Date: Jul. 27, 2017

(54) Vehicle Charging Station Comprising A Supply-Contact Device Mounted On An Arm

(71) Applicant: SIEMENS AKTIENGESELLSCHAFT, MUENCHEN (DE)

(72) Inventors: FLORIAN BUEHS, BERLIN (DE); ANDRE ROMPE, BERLIN KAULSDORF (DE)

(21) Appl. No.: 15/328,097

(22) PCT Filed: Jun. 23, 2015
(86) PCT No.: PCT/EP2015/064067

§ 371 Date: Jan. 23, 2017

(30) Foreign Application Priority Data
Jul. 23, 2014 (AT) A 50509/2014

(51) Int. Cl. B60L 11/18; H02J 7/00

(52) U.S. Cl. CPC B60L 11/1827; B60L 11/1818; H02J 7/0027; H02J 7/0045; B60L 2200/18

(57) ABSTRACT

A vehicle charging station charges an energy accumulator of a battery-driven vehicle. The charging station has a base which is arranged in the vicinity of a pre-defined parking position of the vehicle and an arm. The arm has a first member which extends longitudinally and one end is rotatably mounted in a revolute joint situated on the base and is rotary driven by a rotary drive and a second member mounted in a linear guide on the first member and moves in the direction of the longitudinal extension by a linear drive. The end of the second member facing away from the linear guide is connected to a supply-contact. A control unit controls the rotary drive and the linear drive, such that the supply-contact moves back and forth from an idle position into a working position, in which electrical contact is made between the supply-contact and a receiving-contact device.

### TECHNICAL FIELD

The invention relates in general to the technical field of electric vehicles, in particular to a vehicle charging station and to a method for charging an energy accumulator in an electric vehicle.

### PRIOR ART

In local public transportation, battery-driven transport systems have long been known, for example from DE 24 05 198. Fully electric buses, the entire energy requirements of which are covered by the battery system carried on the vehicle, have recently been put into service. In the metropolitan area of Vienna, fully electric buses of this type are currently in service which obtain their drive power completely from a plurality of lithium ferrite batteries carried on the vehicle, said batteries having a total capacity of approximately 100 kWh and being accommodated on the roof and/or at the rear of the vehicle. These batteries are recharged within approximately 15 minutes during service hours, in each case at a terminal station on the bus line, and overnight when the electric bus is not in service. For charging, a button is pressed to extend a pantograph provided on the vehicle roof of the electric bus and to bring said pantograph into contact with a catenary line system above the electric bus. Before the start of the journey, the contact with the catenary line system is broken, again by a manual switching operation.

A disadvantage here is that the pantograph, together with the lifting and lowering device, has to be carried on the vehicle roof. This calls for additional drive power and reduces the payload of the vehicle. In addition, the lifting and lowering device comprises a plurality of moving parts and, on the roof, the device, together with the drive technology, is exposed to the weather and is susceptible to faults. The design of the extendable pantograph on the vehicle roof also reduces the clearance height of the electric bus. Manual switching operations are required for the charging process, which is undesirable.

### DESCRIPTION OF THE INVENTION

An object of the present invention is to avoid the aforementioned disadvantages and to establish an approach such that charging of the energy accumulator of a battery-driven vehicle is possible without a pantograph, together with the lifting and lowering device, having to be carried by the vehicle, and wherein the charging process is to a large extent automatable.

The object is achieved in a vehicle charging station for charging an energy accumulator of a battery-driven vehicle, in particular an electric bus or a hybrid vehicle, the vehicle parking in a pre-defined parking position during the charging process and having the following:
a) a base which is arranged in the vicinity of the pre-defined parking position;
b) an arm
   i. having a first member which extends longitudinally and one end of which is rotatably mounted in a revolute joint situated on the base and is rotary driven by means of a rotary drive,
   ii. having a second member which is mounted in a linear guide on the first member and can be moved in the direction of the longitudinal extension by means of a linear drive, the end of the second member facing away from the linear guide being connected to a supply-contact device,
   iii. a control unit which controls the rotary drive and the linear drive, such that the supply-contact device can be moved back and forth from an idle position into a working position, in which an electrical contact is made between the supply-contact device and a receiving-contact device fixed on the vehicle.

The object is also achieved in a method for charging the energy accumulator in a battery-driven vehicle, in particular an electric bus or a hybrid vehicle, the vehicle parking, for the purpose of charging, in a pre-defined parking position, with a vehicle charging station, comprising:
a. a base which is arranged in the vicinity of the pre-defined parking position;
b. an arm,
c. having a first member which extends longitudinally and one end of which is rotatably mounted in a revolute joint situated on the base and is rotary driven by means of a rotary drive;
d. having a second member which is mounted in a linear guide on the first member and can be moved in the direction of the longitudinal extension by means of a linear drive, the end of the second member facing away from the linear guide being connected to a supply-contact device;
e. a control unit which controls the rotary drive and the linear drive, characterized by the method step
f. movement of the supply-contact device from an idle position, in which the contacts of the supply-contact device are de-energized, into a working position, in which an electrical contact is made between the supply-contact device and a receiving-contact device provided on the vehicle and arranged in a fixed position with respect to the vehicle and the energy accumulator is charged.

Advantageous embodiments, aspects and details of the invention will emerge from the dependent claims, the description and the attached drawing.

The solution approach is based on the fact that the electrical contact for the charging process is established by a station-side arm. Moving parts are no longer needed on board the vehicle. The elimination of the need for a pantograph carried on the vehicle roof together with its drives reduces the weight of the vehicle and also its clearance height. As moving parts are no longer present on the vehicle, there is also no failure caused by wear and tear or environmental influences.

A preferred embodiment of the vehicle charging station can be one in which the supply-contact device is fashioned such that it interacts with corresponding contact strips of a receiving-contact device which are arranged in the plane of the vehicle roof or in a plane parallel thereto. The on-board contact device can be integrated in the plane of the roof or of a side wall and then necessitates only minor changes to the vehicle silhouette.

It can be advantageous if the individual contact strips of the receiving-contact device are arranged either in the direction of the longitudinal extension of the vehicle or transverse to the longitudinal extension of the vehicle. The requirement with regard to positioning accuracy, in the first-mentioned case in the direction of travel, in the second-mentioned case transverse to the direction of travel, is lower.

If the connection between the second member of the arm and the supply-contact device is established by means of a revolute joint driven by a rotary drive, an asymmetrical loading condition of the vehicle, in which the vehicle is inclined about its longitudinal axis, can be better compensated for.

It can be favorable if, by means of the drives, the individual members of the arm are moved in a working or swivel plane which is oriented approximately transverse to the direction of the longitudinal extension of the parking vehicle. The relative position of base and vehicle can be determined more easily as a result.

### BRIEF DESCRIPTION OF THE DRAWINGS

In order to explain the invention further, reference will be made in the part of the description below to drawings in which further advantageous designs, details and further developments of the invention, based on a non-restrictive exemplary embodiment, can be found, in which

FIG. 1 shows a vehicle charging station having an arm which consists of two members moving in a linear direction of extension, represented in a schematic side view;

FIG. 2 shows FIG. 1 in a plan view;

FIG. 3 shows a plan view of the vehicle roof, having a receiving-contact device which consists of three contact strips arranged in the direction of travel;

FIG. 4 shows a plan view of the vehicle roof, having a receiving-contact device which consists of three contact strips arranged transverse to the direction of travel.

### EMBODIMENT OF THE INVENTION

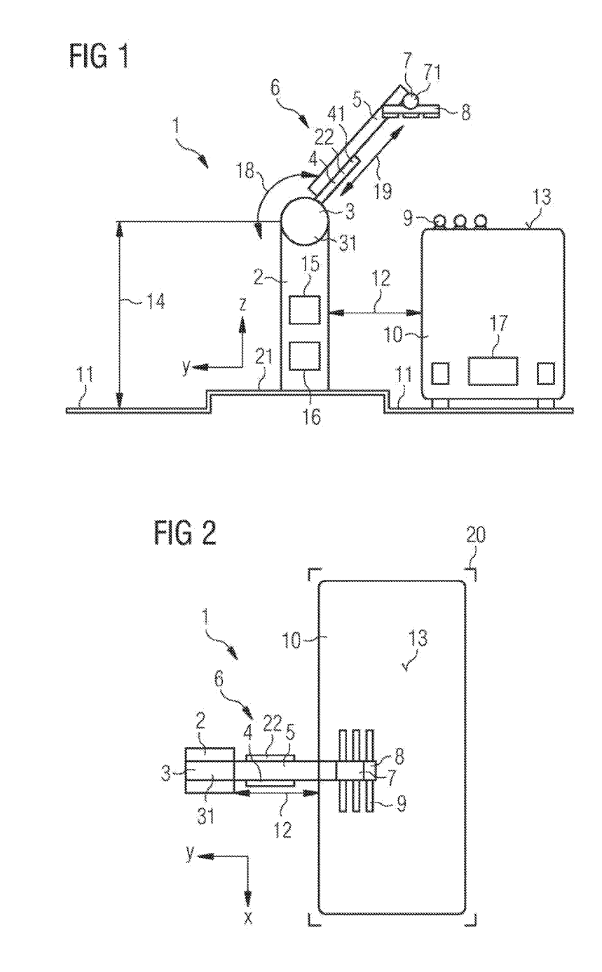

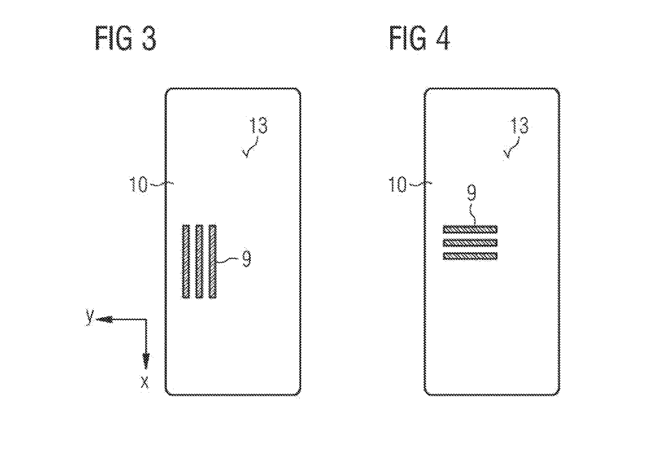

FIG. 1 shows in a simplified representation a vehicle charging station 1 having an arm 6, said arm having two members 4, 5 which are movable in a linear direction of extension. In the vicinity of the charging station 1 is located a vehicle 10, a fully electric bus, parking in a parking position, the entire energy requirements of which vehicle are covered by a battery 17 carried on the vehicle. The charging station 1 consists essentially of a base 2 and the arm 6, which on an end facing away from the base 2 carries a supply-contact device 8. The charging station 1 is fixedly arranged on the roadside 21 in the vicinity of the parking position 20 (FIG. 2) of the vehicle 10. In the idle position shown in FIG. 1, the supply-contact device 8 is located above the vehicle roof 13. In this idle position, the individual contacts of the supply-contact device 8 are de-energized but connectable or connected to a supply network which is not shown in detail in FIG. 1. In order to charge the energy accumulator 17 accommodated in the vehicle 10, the supply-contact device 8 must be moved in a direction toward the vehicle 10, i.e. in the example shown in FIG. 1 be swiveled to the receiving-contact device 9 fixed on the roof 13 and connected electrically to the energy accumulator 17. Before this motion sequence, which is controlled by drives, is explained in detail, the individual components of the vehicle charging station 1 will be described.

The arm 6 consists of a first elongated member 4 and a second elongated member 5. The first member 4 is similar to a swivel arm and is rotatably mounted at one end in a revolute joint 3 which is arranged on the base 2 at a height 14 relative to the road 11. By means of a rotary drive 31, the first member 4 is rotationally movable in the direction of the double-headed arrow 18. In its section facing away from the revolute joint 3, a linear guide 22 is arranged on the first member 4, in which linear guide the second elongated member 5 of the arm 6 is linearly movably mounted. A linear drive 41 moves the second member 5 in the direction of the longitudinal extension of the arm 6, which is indicated in FIG. 1 by means of the double-headed arrow 19. At its end facing away from the base 2 the second member 5 carries the supply-contact device 8, which is connected electrically to a power supply network.

In order to move the supply-contact device 8 from the idle position shown in FIG. 1 to a working position (charging position), the arm 6 is swiveled by means of the rotary drive 31 to the vehicle 10 (clockwise in FIG. 1) and is moved synchronously or asynchronously thereto such that contacts of the supply-contact device 8 contact corresponding contacts of the receiving-contact device 9. A control unit 15 arranged on the base 2 controls the rotary drive 31 and the linear drive 41.

The motion sequence of the supply-contact device 8 from an idle position to a working position and back is effected automatically, controlled by the control unit 15.

As already stated, the vehicle 10 is located in a parking position 20. In order to determine the exact position of the vehicle 10 required for establishing contact, a vehicle-position-detection device 16 is provided on the base 2 which device determines the lateral distance (y direction) between the base 2 and the vehicle 10 and optionally the vehicle position in the direction of travel (x direction) and feeds this information to the control unit 15.

The revolute joint 3 is located at a height 14 from the road 11. The distance 14 (z direction) between the revolute joint 3 and the road 11 is adjustable by means of a linear drive not shown in detail in FIG. 1. In FIG. 1, the distance 14 between road 11 and revolute joint 3 is somewhat greater than the distance between vehicle roof 13 and road 11.

The connection between the supply-contact device 8 and the second member 5 of the arm 6 can, as shown in FIG. 1, be realized by a further revolute joint 7. The revolute joint 7 is driven by a rotary drive 71. This makes it possible when lowering the individual contacts of the contact device 8 onto the vehicle roof 13 to orient these contacts precisely with corresponding contacts of the contact device 9.

FIG. 2 shows a plan view of the vehicle charging station 1 in a working or operating position in which the contact between vehicle 10 and charging station is established. In FIG. 2, the parking position 20 is indicated by markings.

The receiving-contact device 9 is formed by three elongated contact strips (positive, negative, ground) which have been fixedly installed on the vehicle roof 13 parallel to one another and in the direction of the longitudinal extension of the vehicle 10.

In FIG. 2, the receiving-contact device 9 is located not in the center but on a half of the roof of the vehicle 10 facing the base 2. As can be seen from the representation in FIG. 1, however, the arm 6 is also able through appropriate actuation of the drives 31, 41, 71 to charge a vehicle 10 parking to the left of the roadside 21. For this purpose, the rotary drive 31 is swiveled counterclockwise, with corresponding direction of rotation of the rotary drive 71 to the left. The linear drive 41 again takes into account the exact lateral distance 12 between vehicle 10 and base 2.

The drives 31 and 71 are fashioned as electrical position drives. The linear drive 41 is also an electrical position drive connected to a gear mechanism. It is, however, also possible for the drives 31, 41, 71 to be operated pneumatically or hydraulically.

The individual contact elements of the supply-contact device 8 may consist, for example, of metal brushes which are pre-tensioned by means of a spring.

The individual contact elements of the receiving-contact device 9 are fashioned in the form of strips or metal plates and embedded in a contact plate which is manufactured from an electrical insulator. The embedding in the contact plate can be realized such that the metal plates protrude somewhat from the plate surface.

A substantial advantage of the invention is that a pantograph with moving parts is no longer required on the vehicle roof. This saves weight and is maintenance-friendly.

A further advantage is that the docking of the supply-contact device 8 with the receiving-contact device proceeds automatically, controlled by the control device 15, as soon as the vehicle is located in the correct parking position.

Although the invention has been illustrated and described in detail by means of the preferred exemplary embodiments above, the invention is not as a consequence restricted to the disclosed examples. Other variations may be derived herefrom by one skilled in the art without departing from the scope of protection of the invention.

Thus, the number of contacts is of course not restricted to three and may comprise multiple contacts.

The arm 6 may have a plurality of linearly movably guided members.

It is also conceivable for a plurality of arms 6 to be arranged on a base 2, each of said arms being provided with a supply-contact device.

The fixed mounting of the receiving-contact device 9 on the vehicle 10 may be flush with the vehicle silhouette or in a plane which runs parallel relative to the vehicle roof or the vehicle side wall.

The contacts shown as rectangular may also of course have another geometric shape.

### SUMMARY OF THE REFERENCE SIGNS USED

1 vehicle charging station

2 base

3 first revolute joint

4 first member

5 second member

6 arm

7 second revolute joint

8 supply-contact device

9 receiving-contact device

10 vehicle

11 road

12 distance between 2 and 10

13 vehicle roof

14 distance

15 control unit

16 vehicle-position-detection device

17 energy accumulator, battery

18 arrow (swivel movement)

19 arrow (linear movement)

20 parking position

21 roadside

22 linear guide

31 first rotary drive

41 linear drive

71 second rotary drive

1-12. (canceled)

13. A vehicle charging station for charging an energy accumulator of a battery-powered vehicle, the battery-powered vehicle parking in a pre-defined parking position during a charging process, the vehicle charging station comprising:
a base disposed in a vicinity of the pre-defined parking position;
a first revolute joint situated on said base;
a rotary drive;
a linear guide;
a linear drive;
a supply-contact device;
an arm having a first member extending longitudinally and a first end of said first member being rotatably mounted in said first revolute joint and being rotary driven by said rotary drive, said arm further having a second member mounted in said linear guide disposed on said first member and being moved in a direction of a longitudinal extension by means of said linear drive, wherein an end of said second member facing away from said linear guide is connected to said supply-contact device; and
a control unit controlling said rotary drive and said linear drive such that said supply-contact device can be moved back and forth from an idle position into a working position, in the working position electrical contact is made between said supply-contact device and a receiving-contact device fixed on the battery-powered vehicle.

14. The vehicle charging station according to claim 13, wherein said supply-contact device is configured to make the electrical contact with contact strips of the receiving-contact device, the contact strips being disposed in a plane of a vehicle roof or of a side wall of the battery-powered vehicle or in a plane parallel thereto.

15. The vehicle charging station according to claim 13, wherein said supply-contact device is configured to make the electrical contact with contact strips of the receiving-contact device, the contact strips being disposed either in a longitudinal extension of the battery-powered vehicle or transverse to the longitudinal extension of the battery-powered vehicle.

16. The vehicle charging station according to claim 13, further comprising a second revolute joint, a connection between said second member and said supply-contact device is established by means of said second revolute joint.

17. The vehicle charging station according to claim 16, further comprising a further rotary drive driving said second revolute joint.

18. The vehicle charging station according to claim 13, wherein by means of the rotary drive and said linear drive, said first and second members are moved in a working plane which is oriented approximately transverse to the longitudinal extension of the battery-powered vehicle.

19. The vehicle charging station according to claim 13, wherein said first revolute joint is disposed at a distance from a road, the distance being greater than a distance between a vehicle roof and the road.

20. A method for charging an energy accumulator in a battery-powered vehicle, the battery-powered vehicle, for a purpose of charging, parks in a pre-defined parking position, which comprises the steps of:
providing a vehicle charging station containing a base disposed in a vicinity of the pre-defined parking position and an arm having a first member extending longitudinally and one end of the first member is rotatably mounted in a revolute joint situated on the base and is rotary driven by means of a rotary drive, the arm having a second member mounted in a linear guide on the first member and can be moved in a direction of a longitudinal extension by means of a linear drive, wherein an end of the second member facing away from the linear guide is connected to a supply-contact device, the vehicle charging station further having a control unit controlling the rotary drive and the linear drive; and
moving the supply-contact device from an idle position, in which contacts of the supply-contact device are de-energized, into a working position, in which electrical contact is made between the supply-contact device and a receiving-contact device provided on the battery-powered vehicle and disposed in a fixed position with respect to the battery-powered vehicle and the energy accumulator is charged.

21. The method according to claim 19, wherein when the supply-contact device is moved from the idle position to the working position, the first and second members are moved in a swivel plane which runs substantially transverse to the longitudinal extension of the battery-powered vehicle.

22. A battery-driven, non-rail bound vehicle comprising:
a vehicle roof;
a side wall; and
a receiving-contact device mounted in a fixed position on said vehicle roof or on said side wall of the vehicle and having at least two elongated contact elements disposed either in a direction of a longitudinal extension of the vehicle or transverse to the longitudinal extension of the vehicle.

23. The vehicle according to claim 22, wherein said elongated contact elements are disposed in a plane of said vehicle roof or of said side wall of the vehicle or in a plane respectively parallel thereto.

24. The vehicle according to claim 22, further comprising an insulating part, said elongated contact elements of said receiving-contact device are embedded at least partially in said insulating part.
